(19) United States
(12) Patent Application Publication
(10) Pub. No.: US 2020/0136114 A1
(43) Pub. Date: Apr. 30, 2020

(54) POWER STORAGE DEVICE

(71) Applicant: TOYOTA JIDOSHA KABUSHIKI KAISHA, Toyota-shi (JP)

(72) Inventors: Tadahiro KONDO, Toyota-shi (JP); Satoshi MORIOKA, Okazaki-shi (JP); Nobuyoshi FUJIWARA, Mishima-shi (JP)

(73) Assignee: TOYOTA JIDOSHA KABUSHIKI KAISHA, Toyota-shi (JP)

(21) Appl. No.: 16/661,397

(22) Filed: Oct. 23, 2019

(30) Foreign Application Priority Data
Oct. 24, 2018 (JP) 2018-199691

(51) Int. Cl. H01M 2/16

(52) U.S. Cl. CPC H01M 2/166

(57) ABSTRACT

A power storage device includes a first power storage cell and a second power storage cell that are spaced from each other in a predetermined direction and located so that a side surface of the first power storage cell and a side surface of the second power storage cell face each other, a divider that is made of a thermoplastic resin and interposed between the side surface of the first power storage cell and the side surface of the second power storage cell, and a spacer that is made of an inorganic material and disposed to pass through the divider in the predetermined direction.

This nonprovisional application is based on Japanese Patent Application No. 2018-199691 filed on Oct. 24, 2018, with the Japan Patent Office, the entire contents of which are hereby incorporated by reference.

### BACKGROUND

### Field

The present disclosure relates to a power storage device.

### Description of the Background Art

A power storage device is used as a power source or the like, mounted on vehicles such as electric vehicles and hybrid electric vehicles. A power storage device includes a case and a power storage module accommodated in the case. A power storage module is formed by stacking a plurality of power storage cells in a predetermined direction. Typically, as is disclosed by Japanese Patent Laying-Open No. 2010-097693, restraint end plates are disposed at both ends of the power storage module in a predetermined direction and a divider is disposed between the power storage cells adjacent to each other in a predetermined direction.

### SUMMARY

When a problem such as overcharging or damage occurs to a power storage cell, heat may be produced in the power storage cell. In a configuration composed of a stack of a plurality of power storage cells stacked in a predetermined direction, heat produced in one of the power storage cells upon overcharging or the like can be transmitted to an adjacent power storage cell.

In the disclosure by Japanese Patent Laying-Open No. 2010-097693, the divider comprises an ester-based matrix and a spacer is made of thermosetting resin and embedded in the matrix. Japanese Patent Laying-Open No. 2010-097693 teaches that, even when heat is produced and the heat melts the entire divider (matrix), the spacer remains to exist between adjacent power storage cells and thereby retain the gap between the adjacent power storage cells.

In recent years, power storage cells have been demanded to have more and more capacity. As the capacity of a power storage cell increases, the amount of heat produced upon overcharging and/or damage also increases to raise the temperature. Therefore, it is desirable to provide a power storage device that is improved, compared to the configuration disclosed by Japanese Patent Laying-Open No. 2010-097693, in the capability of mitigating contact between adjacent power storage cells when overcharging, damage, and/or the like occurs to one of the power storage cells.

An object of the present disclosure is to provide a power storage device that is improved, compared to a conventional one, in the capability of mitigating contact between adjacent power storage cells when overcharging, damage, and/or the like occurs to one of the power storage cells.

The power storage device includes a first power storage cell and a second power storage cell that are spaced from each other in a predetermined direction and located so that a side surface of the first power storage cell and a side surface of the second power storage cell face each other, a divider that is made of a thermoplastic resin and interposed between the side surface of the first power storage cell and the side surface of the second power storage cell, and a spacer that is made of an inorganic material and disposed to pass through the divider in the predetermined direction.

In this power storage device, the inorganic material has a melting point (herein called a heat-resistant temperature) higher than the melting point of a thermosetting resin or a thermoplastic resin, is therefore less likely to melt upon receiving heat from a power storage cell, and is consequently capable of retaining the gap between the first power storage cell and the second power storage cell that are adjacent to each other.

In the power storage device, the divider has an opening passing through the divider in the predetermined direction and the spacer may be disposed inside the opening by press-fit.

Regarding the power storage device, the spacer may be easily disposed in the divider and therefore production costs may be reduced.

In the power storage device, the spacer may be columnar in shape extending in the predetermined direction.

In the power storage device, the spacer may be easily disposed in the divider and therefore, even when the divider has melted, an air pathway is likely to be left between the first power storage cell and the second power storage cell.

In the power storage device, the side surface of the first power storage cell has a central portion and an outer circumferential portion. The central portion is located at a center of the side surface of the first power storage cell in an in-plane direction orthogonal to the predetermined direction, and the outer circumferential portion defines an outer circumference of the side surface of the first power storage cell in the in-plane direction. Also in the power storage device, a first distance between the spacer and the central portion in a reference direction is shorter than a second distance between the spacer and the outer circumferential portion in the reference direction. The reference direction is a direction of a line connecting the spacer and the central portion.

When gas is generated from a power generation component in a power storage cell, the power storage cell is likely to swell at a central region of the side surface thereof. In the power storage device according to the present disclosure, in contrast, the spacer is disposed near a central region of the side surface of the first power storage cell and is therefore capable of effectively resisting the swelling of the first power storage cell.

In the power storage device, the divider may include a plurality of the spacers.

In the power storage device, even when the divider has melted, the plurality of spacers are capable of withstanding a load applied upon an abnormal event and thereby effectively mitigating contact between adjacent power storage cells.

In the power storage device, the plurality of spacers may be located to satisfy a relationship of point symmetry about a predetermined location in a plane orthogonal to the predetermined direction or to satisfy a relationship of line symmetry about a predetermined straight line in the plane orthogonal to the predetermined direction.

In the power storage device, even when the divider has melted, the plurality of spacers are capable of using evenly distributed forces to withstand a load applied upon an abnormal event and thereby effectively mitigating contact between adjacent power storage cells.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a plan view of a power storage device 10 according to an embodiment.

FIG. 2 is a sectional view on the arrow II-II in FIG. 1.

FIG. 3 is an exploded perspective view of a first power storage cell 1, a divider 3, and spacers 4a to 4d included in power storage device 10 according to the embodiment.

FIG. 4 is a view of divider 3 and first power storage cell 1 viewed from the direction shown by the arrow IV in FIG. 3.

FIG. 5 is a schematic sectional view of power storage device 10 according to the embodiment with divider 3 having melted due to heat.

FIG. 6 is a schematic sectional view of a power storage device of a comparative example with divider 3 having melted due to heat.

FIG. 7 is a perspective view of a divider 3M and spacers 4a to 4e included in a power storage device according to a first variation of the embodiment.

FIG. 8 is a perspective view of a divider 3N and spacer 4a included in a power storage device according to a second variation of the embodiment.

### DESCRIPTION OF THE PREFERRED EMBODIMENTS

A description will be given of embodiments of the present invention, referring to drawings. In the description below, the same or equivalent parts are denoted by the same reference numeral and an overlapping description may not necessarily be provided.

(Power Storage Device 10)

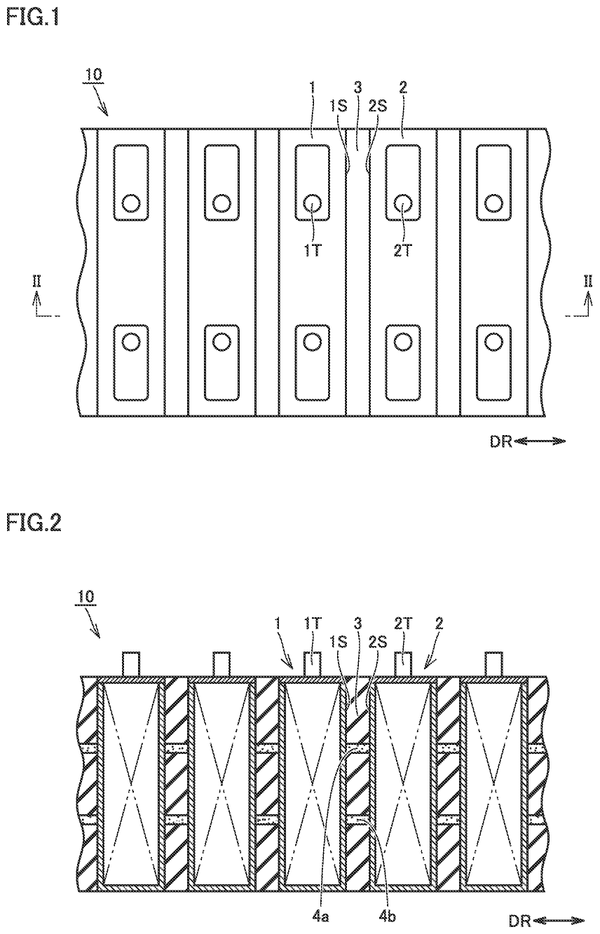

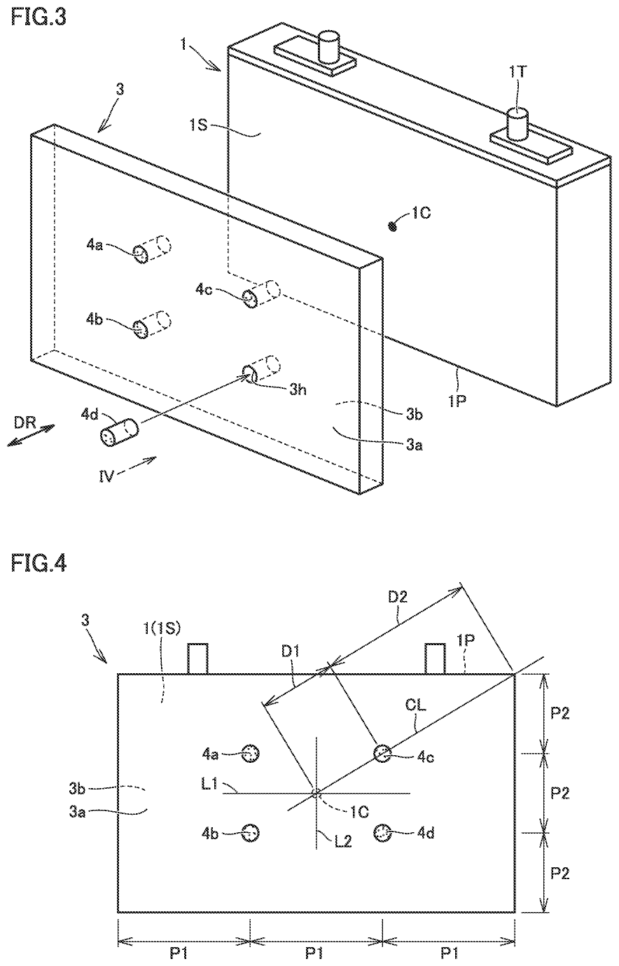

FIG. 1 is a plan view of a power storage device 10 according to an embodiment, viewed from, for example, a direction parallel to the vertical direction. FIG. 2 is a sectional view on the arrow II-II in FIG. 1, showing a hypothetical section of power storage device 10 cut in a direction parallel to the vertical direction. FIG. 3 is an exploded perspective view of a first power storage cell 1, a divider 3, and spacers 4a to 4d included in power storage device 10 according to the embodiment. FIG. 4 is a view of divider 3 and first power storage cell 1 viewed from the direction shown by the arrow IV in FIG. 3.

As shown in FIGS. 1 to 4, power storage device 10 includes a plurality of power storage cells stacked in a predetermined direction (the direction shown by the arrow DR), a plurality of dividers 3 each of which is disposed between two adjacent power storage cells, and a plurality of spacers 4a, 4b, 4c, 4d (FIGS. 3, 4) disposed in each of the plurality of dividers 3.

Each power storage cell is composed of a casing and a power generation component (not shown) accommodated in the casing. The power storage cell as a whole constitutes a secondary battery, such as a nickel-metal hydride battery or a lithium-ion battery. The casing of the power storage cell has a prismatic shape. The power storage cell may include either a liquid electrolyte or a solid electrolyte.

In the present embodiment, the plurality of power storage cells include a first power storage cell 1 and a second power storage cell 2 that are spaced from each other in the predetermined direction (the direction shown by the arrow DR), and the plurality of power storage cells are located so that a side surface 1S of first power storage cell 1 and a side surface 2S of second power storage cell 2 face each other. On the top of first power storage cell 1, a pair of terminals 1T are disposed. On the top of second power storage cell 2, a pair of terminals 2T are disposed. Terminals 1T, 2T, and the like are electrically connected to each other via bus bars (not shown) and/or the like, and thereby the plurality of power storage cells are formed into a single power storage module.

At each end of the power storage module in the predetermined direction (the direction shown by the arrow DR), a restraint end plate (not shown) is disposed. A restraint band (not shown) having pressurizing, fixing action is used to hold the power storage module as a single-piece module. Each power storage cell may produce heat upon charge and discharge. On an outer surface (a bottom side, for example) of the plurality of power storage cells, a heat exchanger or the like may be disposed as appropriate for cooling. The heat exchanger or the like may be disposed in contact with the outer surface of the plurality of power storage cells.

Divider 3 is a plate having side surfaces 3a, 3b (FIG. 3). Divider 3 is made of a thermoplastic resin and interposed between side surface 1S of first power storage cell 1 and side surface 2S of second power storage cell 2. Examples of the thermoplastic resin include polypropylene, polyethylene, polyvinyl chloride, and polystyrene. Forming divider 3 as a plate may be easily achieved by resin molding.

As shown in FIGS. 2 to 4, a single divider 3 according to the present embodiment includes four spacers 4a to 4d in total. Spacers 4a to 4d are made of an inorganic material. The inorganic material has a melting point (heat-resistant temperature) higher than the melting point of a thermosetting resin or a thermoplastic resin. The inorganic material may be a glass-based material or may be a ceramic-based material (such as silica, alumina, or zirconia). Each of spacers 4a to 4d is columnar in shape extending in the predetermined direction (the direction shown by the arrow DR). The columnar shape may be any one of columnar shapes including a polygonal column shape, a cylinder shape, and an elliptic cylinder shape.

Spacers 4a to 4d are disposed to pass through divider 3 in the predetermined direction (the direction shown by the arrow DR). Each of spacers 4a to 4d is surrounded by divider 3. Each end of each of spacers 4a to 4d in the predetermined direction (the direction shown by the arrow DR) is exposed at a surface of divider 3. As shown in FIG. 2, the length of each of spacers 4a to 4d in the predetermined direction (the direction shown by the arrow DR) is the same or substantially the same as the thickness of divider 3 in the predetermined direction (the direction shown by the arrow DR). Each end face of each of spacers 4a to 4d in the predetermined direction (the direction shown by the arrow DR) is in contact with side surface 1S or 2S.

For instance, divider 3 has openings 3h passing through divider 3 in the predetermined direction (the direction shown by the arrow DR). Each of spacers 4a to 4d may be disposed inside openings 3h by press-fit, which is an inexpensive and easy technique. Spacers 4a to 4d may be formed as integral parts of divider 3 by insert molding. Each end of each of spacers 4a to 4d in the predetermined direction (the direction shown by the arrow DR) is still exposed at a surface of divider 3 when insert molding is employed.

In the configuration described above, the plurality of power storage cells and dividers 3 arranged in the predetermined direction (the direction shown by the arrow DR) receive an inwardly-directed force applied in the predetermined direction (the direction shown by the arrow DR) by the pair of end plates. With this force, the pair of end plates sandwich the plurality of power storage cells and dividers 3 and hold them. Receiving this force, the power storage cells come into contact with dividers 3 and the end plates.

Power storage device 10 having the above-described configuration may be used not only in hybrid vehicles but also in electric vehicles and fuel-cell electric vehicles. Power storage device 10 may be used in hybrid vehicles of a series mode, a parallel mode, and a series/parallel mode. Power storage device 10 may be used not only in hybrid vehicles with two dynamo-electric machines but also in the so-called one-motor hybrid vehicles with a single dynamo-electric machine.

(Functions and Effects)

When any one of the plurality of power storage cells constituting power storage device 10 (for example, first power storage cell 1) produces heat, the temperature of divider 3 adjacent to the power storage cell (first power storage cell 1) also increases. When gas is generated from a power generation component in first power storage cell 1, the temperature of first power storage cell 1 may excessively increase. Divider 3 is made of a thermoplastic resin and melts as the temperature increases. When the temperature of divider 3 exceeds the melting point of the material (thermoplastic resin) of divider 3, divider 3 starts to melt.

When power storage device 10 (power storage cell) is under normal conditions (charge-discharge conditions), divider 3 retains its shape. The melting point of the material constituting divider 3 is higher than both the temperature of the power storage cell under normal conditions and the environmental temperature. The normal conditions refer to, for example, conditions under which charge and discharge is carried out within a predetermined range of charging capacity (SOC, State of Charge) for the vehicle.

In contrast, the melting point of the material constituting divider 3 is lower than the temperature of a power storage cell that is under abnormal conditions upon overcharging and/or the like. Only when a power storage cell is under abnormal conditions and the temperature thereof is excessively increased, divider 3 melts. Divider 3 at least partially melts and thereby absorbs heat from the power storage cell.

The thermal energy generated in the power storage cell is used as energy for melting divider 3. This mitigates the transfer of heat produced in the power storage cell to other power storage cells. In the configuration in which divider 3 is made of a thermoplastic resin, divider 3 may readily melt and, thereby, thermal energy generated in a power storage cell may be absorbed by divider 3 with high efficiency. The configuration in which divider 3 is made of a material with a high thermal resistance (a thermoplastic resin) makes it possible to reduce the thickness of divider 3, to improve mounting properties, and/or to mount more cells within a particular amount of space.

In contrast, spacers 4a to 4d disposed in divider 3 are made of an inorganic material and therefore do not melt when receiving heat from a power storage cell. When divider 3 interposed between, for example, first power storage cell 1 and second power storage cell 2 has entirely melted as shown in FIG. 5, there are spacers 4a to 4d alone being left between first power storage cell 1 and second power storage cell 2.

First power storage cell 1 and second power storage cell 2 sandwiching spacers 4a to 4d constantly receive an inwardly-directed force (namely, a force applied in a direction in which the first and second power storage cells approach mutually) applied in the predetermined direction (the direction shown by the arrow DR). Prior to the melting of divider 3, each end of each of spacers 4a to 4d is exposed at a surface of divider 3 and is in contact with either first power storage cell 1 or second power storage cell 2.

Even when divider 3 has melted, spacers 4a to 4d remain as they are without changing their positions between first power storage cell 1 and adjacent second power storage cell 2. Spacers 4a to 4d are capable of retaining the gap between first power storage cell 1 and adjacent second power storage cell 2. In addition, use of spacers 4a to 4d may improve strength of divider 3.

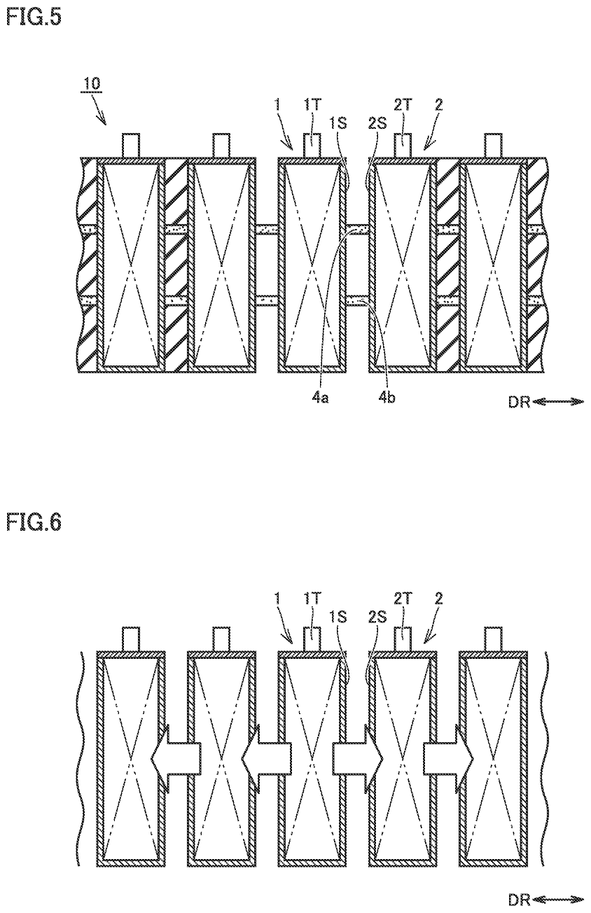

When divider 3 has melted, a predetermined amount of space (an air layer) is formed between adjacent power storage cells. The presence of the air layer mitigates heat of a power storage cell under abnormal conditions from being transferred to other power storage cells. The presence of the air layer also mitigates other power storage cells from producing heat one after another in a chain reaction manner. FIG. 6 is a schematic sectional view of a power storage device of a comparative example with divider 3 having melted due to heat.

As stated in an earlier paragraph, power storage cells have been demanded to have more and more capacity in recent years. As the capacity of a power storage cell increases, the amount of heat produced upon overcharging and/or damage also increases to raise the temperature even more. Spacers 4a to 4d used in the present embodiment are made of an inorganic material and, therefore, have a sufficiently high melting point (heat-resistant temperature). If the melting point (heat-resistant temperature) of spacers is lower than the melting point of an inorganic material, the spacers may melt together with the divider to allow power storage cells to come into contact with each other as shown in FIG. 6. The present embodiment is capable of effectively mitigating this phenomenon.

There are spacers 4a to 4d alone to be present between adjacent power storage cells and, therefore, an air pathway may be left there. When spacers 4a to 4d are columnar in shape, the likelihood of an air pathway to be left is higher. Heat of a power storage cell under abnormal conditions may be diffused in a plurality of directions and the transfer of heat to other power storage cells is mitigated. When divider 3 is made of a thermoplastic resin, the entire divider 3 may easily melt and thereby a plurality of air pathways may be formed between power storage cells.

The number, the shape, and the positions of spacers 4a to 4d and the directions in which spacers 4a to 4d are disposed (orientation) may be selected as appropriate so that use of spacers 4a to 4d serves to retain the gap between adjacent power storage cells. Spacers 4a to 4d may be spherical.

For instance, referring to FIGS. 3 and 4, side surface 1S of first power storage cell 1 has a central portion 1C and an outer circumferential portion 1P. Central portion 1C is located at a center of side surface 1S in an in-plane direction orthogonal to the predetermined direction (the direction shown by the arrow DR), and outer circumferential portion 1P defines an outer circumference of side surface 1S in the in-plane direction. As shown in FIG. 4, a first distance D1 between spacer 4c and central portion 1C in a reference direction CL may be set to be shorter than a second distance D2 between spacer 4c and outer circumferential portion 1P in reference direction CL. Reference direction CL is a direction of a line connecting spacer 4c and central portion 1C when divider 3 and first power storage cell 1 are viewed from a direction parallel to the predetermined direction (the direction shown by the arrow DR). Reference direction CL extends straight in a plane orthogonal to the predetermined direction (the direction shown by the arrow DR).

Spacer 4c is located to satisfy the above-described relationship. This means that spacer 4c is located near a central region of side surface 1S of first power storage cell 1. When gas is generated from a power generation component in first power storage cell 1, first power storage cell 1 is likely to swell at a central region of side surface 1S. Spacer 4c is capable of effectively resisting the swelling of first power storage cell 1. Desirably, the same relationship is satisfied by all other spacers 4a, 4b, 4d.

From the viewpoints of design, production, and the like, spacers 4a to 4d may be disposed on lines that divide side surface 1S of first power storage cell 1 into three equal portions in a width direction referring to FIG. 4. In this configuration, spacers 4a, 4c are spaced at regular intervals P1 in the width direction and spacers 4b, 4d are spaced at regular intervals P1 in the width direction. Similarly, spacers 4a to 4d may be disposed on lines that divide side surface 1S of first power storage cell 1 into three equal portions in a height direction. In this configuration, spacers 4a, 4b are spaced at regular intervals P2 in the height direction and spacers 4c, 4d are spaced at regular intervals P2 in the height direction. These configurations are capable of effectively mitigating contact between adjacent power storage cells.

Moreover, the plurality of spacers 4a to 4d may be located to satisfy a relationship of point symmetry about a predetermined location (for example, central portion 1C) in the plane orthogonal to the predetermined direction (the direction shown by the arrow DR). Alternatively, the plurality of spacers 4a to 4d may be located to satisfy a relationship of line symmetry about a predetermined straight line in the plane orthogonal to the predetermined direction (the direction shown by the arrow DR). For instance, the predetermined straight line may be a straight line L1 that passes through central portion 1C and is parallel to the width direction of side surface 1S. For instance, the predetermined straight line may be a straight line L2 that passes through central portion 1C and is parallel to the height direction of side surface 1S. Spacers 4a to 4d are capable of using evenly distributed forces to withstand the load in the width direction and/or in the height direction applied upon an abnormal event and thereby effectively mitigating contact between adjacent power storage cells.

(First Variation)

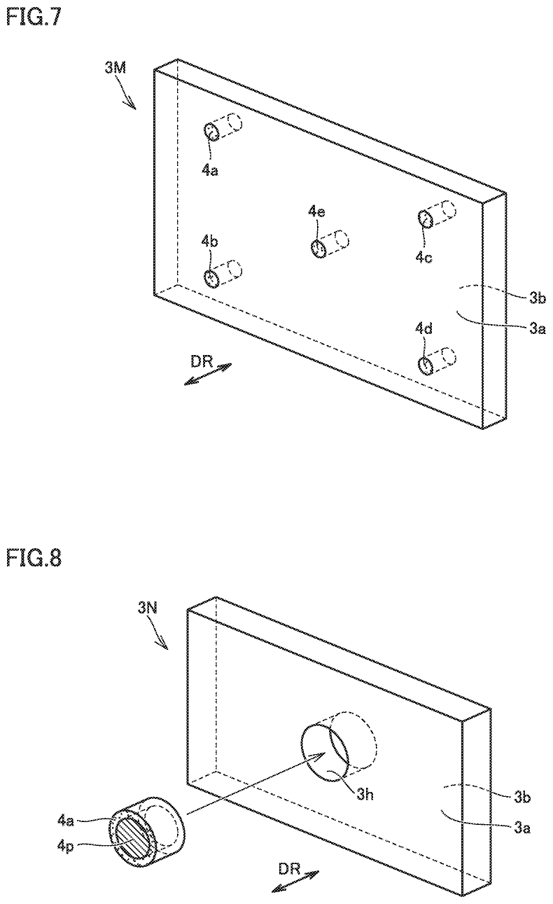

As in the case of a divider 3M in FIG. 7, the number of spacers may be five (spacers 4a to 4e). In divider 3M, spacers 4a to 4d are disposed close to an outer circumferential portion (outer circumferential portion 1P) and spacer 4e is disposed close to a central portion (central portion 1C). This configuration may also have functions and effects similar to the above-described functions and effects.

(Second Variation)

As in the case of a divider 3N in FIG. 8, the number of spacers may be one (spacer 4a). In divider 3N, spacer 4a has a cylinder shape and the interior of spacer 4a is filled with a resin 4p. Spacer 4a is disposed close to a central portion (central portion 1C). The inorganic material has a high heat resistance (melting point) and may also have a high thermal conductivity. Compared to a spacer having a cylinder shape with the same diameter as that of spacer 4a, spacer 4a according to this variation having resin 4p is capable of reducing heat transfer between power storage cells. When there is a hermetically enclosed space in the interior of spacer 4a, condensation may occur. However, the presence of resin 4p mitigates condensation.

The embodiments and examples disclosed herein are illustrative and non-restrictive in any respect. The technical scope indicated by the claims is intended to include any modifications within the scope and meaning equivalent to the terms of the claims.

What is claimed is:

1. A power storage device comprising:
a first power storage cell and a second power storage cell, the first power storage cell and the second power storage cell being spaced from each other in a predetermined direction and located so that a side surface of the first power storage cell and a side surface of the second power storage cell face each other;
a divider made of a thermoplastic resin and interposed between the side surface of the first power storage cell and the side surface of the second power storage cell; and
a spacer made of an inorganic material and disposed to pass through the divider in the predetermined direction.

2. The power storage device according to claim 1, wherein
the divider defines an opening passing through the divider in the predetermined direction, and
the spacer is disposed inside the opening by press-fit.

3. The power storage device according to claim 1, wherein the spacer is columnar in shape extending in the predetermined direction.

4. The power storage device according to claim 1, wherein
the side surface of the first power storage cell has a central portion and an outer circumferential portion, the central portion being located at a center of the side surface of the first power storage cell in an in-plane direction orthogonal to the predetermined direction, the outer circumferential portion defining an outer circumference of the side surface of the first power storage cell in the in-plane direction, and
a first distance between the spacer and the central portion in a reference direction is shorter than a second distance between the spacer and the outer circumferential portion in the reference direction, the reference direction being a direction of a line connecting the spacer and the central portion.

5. The power storage device according to claim 1, wherein the divider comprises a plurality of the spacers.

6. The power storage device according to claim 5, wherein the plurality of the spacers are located to satisfy a relationship of point symmetry about a predetermined location in a plane orthogonal to the predetermined direction or a relationship of line symmetry about a predetermined straight line in the plane orthogonal to the predetermined direction.
